(19) United States
(12) Patent Application Publication
(10) Pub. No.: US 2026/0330478 A1
(43) Pub. Date: Oct. 22, 2026

(54) PRODUCT DISTRIBUTION MANAGEMENT DEVICE AND PRODUCT DISTRIBUTION MANAGEMENT METHOD USING THE SAME

(71) Applicant: NBST Co., Ltd., Pyeongtaek-si (KR)

(72) Inventor: In Suk CHO, Seoul (KR)

(21) Appl. No.: 19/443,681

(22) Filed: Jan. 8, 2026

(30) Foreign Application Priority Data
Jan. 15, 2025 (KR) 10-2025-0005960

(51) Int. Cl. G06Q 30/018

(52) U.S. Cl. CPC G06Q 30/0185

(57) ABSTRACT

Provided are a product distribution management device capable of identifying an abnormal price of a product and tracing a distribution channel of the product and accurately determining whether the product is counterfeit using a combination of a visible mark and an invisible mark, and a product distribution management method using the same. A product distribution management device according to an aspect of the present invention is a product distribution management device for tracing an anomalous sales act of a product by recognizing a counterfeit prevention means provided on the product and includes an administrator terminal including a processor configured to identify a first mark which is an invisible mark and provided on the product, and a user server used by a user and configured to identify a second mark which is a visible mark and provided on the product, wherein the processor determines distribution possibility of a counterfeit by identifying an abnormal price of the product and tracing a distribution channel of the product, and scans and matches a first mark and a second mark in the product that is highly likely to be counterfeit to determine whether the product is counterfeit.

### CROSS-REFERENCE TO RELATED APPLICATION

This application claims priority to and the benefit of Korean Patent Application No. 2025-0005960, filed on Jan. 15, 2025, the disclosure of which is incorporated herein by reference in its entirety.

### BACKGROUND

### 1. Field of the Invention

The present invention relates to a product distribution management device and a product distribution management method using the same, and more particularly, to a product distribution management device capable of accurately identifying an abnormal price of a product and tracing a distribution channel of the product, and a product distribution management method using the same.

### 2. Discussion of Related Art

Various technologies are being proposed to prevent counterfeiting and tampering of expensive goods or products requiring authenticity. Conventionally, technologies using micropatterns, braille, holograms, radio-frequency identifications (RFIDs), etc. have been mainly used to prevent counterfeiting and tampering of products. However, these conventional technologies have limitations in that it is not easy for general users to detect counterfeiting and alteration of products or have a problem of high costs to manufacture counterfeiting and tampering prevention means. In order to fundamentally solve the problems of the conventional counterfeiting and tampering prevention means described above, various methods have been proposed, a method using a color nanoscale composite such as a photonic crystal among various methods has been proposed. A photonic crystal is a material or crystal that has the property of reflecting only a specific wavelength of incident light and sending the remaining wavelengths of light, thereby exhibiting a color corresponding to that wavelength, and representative examples of the photonic crystal include butterfly wings, beetle shells, etc. Although these materials do not contain pigments, they may produce unique colors because they contain a unique photonic crystal structure.

Despite various methods of preventing counterfeiting and tampering, such as photonic crystals, counterfeiting and tampering may occur. In this case, technologies may be required to estimate or identify information related to counterfeiting, such as the number of instances of counterfeiting and tampering, who committed them, and where they occurred.

### SUMMARY OF THE INVENTION

The present invention is directed to providing a product distribution management device capable of identifying an abnormal price of a product and tracing a distribution channel of the product and accurately determining whether the product is counterfeit using a combination of a visible mark and an invisible mark, and a product distribution management method using the same.

However, objects of the present invention are not limited to the above-described object and other objects that are not described may be clearly understood by those skilled in the art from the following descriptions.

According to an aspect of the present invention, there is provided a product distribution management device is a product distribution management device for tracing an anomalous sales act of a product by recognizing a counterfeit prevention means provided on the product and includes an administrator terminal including a processor configured to identify a first mark which is an invisible mark and provided on the product, and a user server used by a user and configured to identify a second mark which is a visible mark and provided on the product, wherein the processor determines distribution possibility of a counterfeit by identifying an abnormal price of the product and tracing a distribution channel of the product, and scans and matches a first mark and a second mark in the product that is highly likely to be counterfeit to determine whether the product is counterfeit.

The processor may identify the abnormal price of the product sold at an abnormal price compared to a normal price of the product and notify a manufacturer of the product of the abnormal price of the product sold at the abnormal price, and identify the abnormal price of the product sold at the abnormal price compared to the normal price of the product and trace the distribution channel of the product sold at the abnormal price.

When tracing the distribution channel of the product sold at the abnormal price, the processor may determine which distribution channel is an anomalous channel.

When determining which distribution channel is an anomalous channel, the process may consider at least one of authenticity information of the product, price change information of the product, anomaly symptom information of the distribution channel, expiration date information, and seller certification status information, and determine weights assigned to each of the authenticity information of the product, the price change information of the product, the anomaly symptom information of the distribution channel, the expiration date information, and the seller certification status information, according to a type of the product.

When tracing the distribution channel of the product sold at the abnormal price, the processor may consider price information, sales date information, and sales location information of the product that is sold by each distributor distributing the product.

When tracing the distribution channel of the product sold at the abnormal price, the processor may determine first weights assigned to each of the price information, the sales date information, and the sales location information of the product that is sold by each distributor, and when it is determined that the product sold by the distributor is a counterfeit, send a penalty notice to a distributor who sold the counterfeit in consideration of the determined first weight.

When sending the penalty notice to the distributor who sold the counterfeit, the processor may determine second weights assigned to each of reliability of the distributor, a sales pattern of the distributor, and distribution history of the distributor, and adjust a degree of the penalty notice intended to be sent to the distributor who sold the counterfeit, in consideration of the first weights and the second weights.

According to another aspect of the present invention, there is provided a product distribution management method using a product distribution management device for tracing an anomalous sales act of a product by recognizing a counterfeit prevention means provided on the product, which includes determining distribution possibility of a counterfeit by identifying an abnormal price of the product and tracing a distribution channel of the product, and scanning and matching a first mark, which is an invisible mark, and a second mark, which is a visible mark, in the product that is highly likely to be counterfeit to determine whether the product is counterfeit.

### BRIEF DESCRIPTION OF THE DRAWINGS

The following drawings attached to this specification illustrate exemplary embodiments of the present invention and, together with the detailed description of the present invention which will be described below, serve to further understand the technical idea of the present invention, and therefore, the present invention should not be interpreted as being limited to matters described in such drawings.

The above and other objects, features and advantages of the present invention will become more apparent to those of ordinary skill in the art by describing exemplary embodiments thereof in detail with reference to the accompanying drawings, in which:

FIG. 1 is a diagram illustrating a product distribution management device according to an embodiment of the present invention;

FIG. 2 is a diagram illustrating an example of a product distribution management method performed by the product distribution management device of FIG. 1;

FIGS. 3 to 5 are diagrams illustrating other examples of the product distribution management method performed by the product distribution management device of FIG. 1; and

FIG. 6 is a flowchart illustrating a product distribution management method according to an embodiment of the present invention.

### DETAILED DESCRIPTION OF EXEMPLARY EMBODIMENTS

Hereinafter, exemplary embodiments of the present invention will be described in detail with reference to the accompanying drawings. Prior to this, terms and words used in following description and drawings should not be interpreted as being limited to commonly used meanings or meanings in dictionaries and should be interpreted with meanings and concepts which are consistent with the technological scope of the present invention based on the principle that the inventors have appropriately defined concepts of terms in order to describe the present invention in the best way.

Therefore, since embodiments described in this specification and configurations illustrated in the drawings are only exemplary embodiments and do not represent the overall technological scope of the present invention, it is understood that the present invention covers various equivalents, modifications, and substitutions at the time of filing of this application.

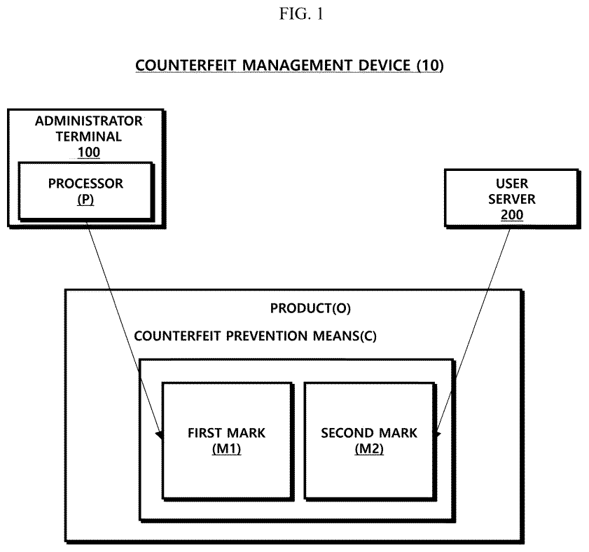

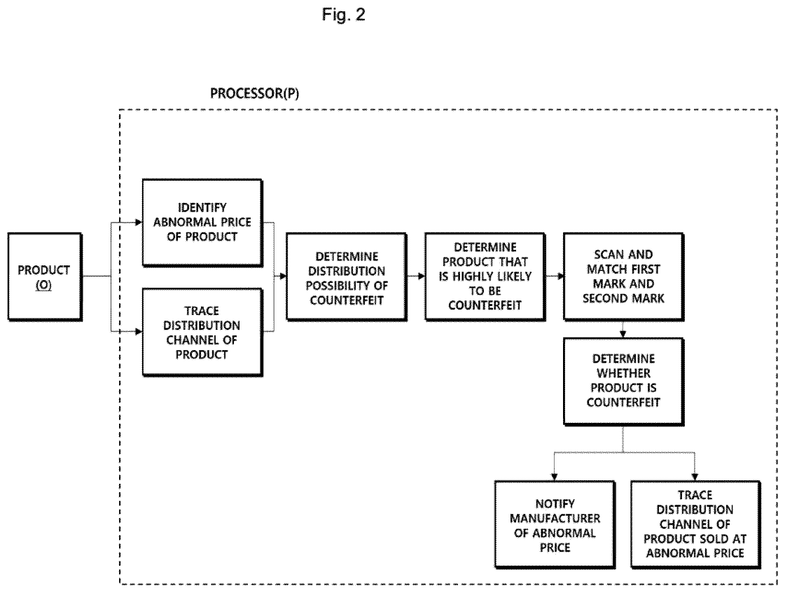

FIG. 1 is a diagram illustrating a product distribution management device 10 according to an embodiment of the present invention, and FIG. 2 is a diagram illustrating an example of a product distribution management method performed by the product distribution management device 10 of FIG. 1.

Referring to FIGS. 1 and 2, the product distribution management device 10 according to the embodiment of the present invention may trace an anomalous sales act of a product O by recognizing a counterfeit prevention means C provided on the product O. The product distribution management device 10 may include an administrator terminal 100 and a user server 200. Further, the product O may correspond to one of various objects, such as daily necessities (e.g., cosmetic containers and the like), parts of electronic products, etc. In addition, the counterfeit prevention means C may include a first mark M1 and a second mark M2.

The administrator terminal 100 may include a processor P that is configured to identify the first mark M1 which is an invisible mark and provided on the product O. The administrator terminal 100 may be used by an administrator. In this case, the administrator terminal 100 may be operated in a mobile application manner. As an example, the first mark M1 may be a mark that is identifiable in a manner that is invisible to the human eye, may include ultraviolet (UV) ink, an infrared (IR) marker, a radio-frequency identification (RFID) tag, a material that can be recognized through a chemical reaction, etc., and may be identified through the administrator terminal 100 (e.g., UV light, a laser of a specific wavelength, and a device that detects a signal of a specific wavelength), which is a special device. Further, the administrator terminal 100 may be a mobile device used by the administrator. In addition, the administrator terminal 100 may further include a memory (not illustrated) and may be configured to store instructions for a computer program or application that implements a method of identifying the first mark M1, and the processor P may execute the instructions stored in the memory to execute the program or application. For example, the memory may be implemented as a non-volatile memory such as a read-only memory (ROM), a programmable ROM (PROM), an erasable programmable ROM (EPROM), an electrically erasable programmable ROM (EEPROM), a flash memory, a phase-change random access memory (PRAM), a magnetoresistive RAM (MRAM), a resistive RAM (RRAM), a ferroelectric RAM (FRAM), etc., or as a volatile memory such as a dynamic random access memory (DRAM), a static random access memory (SRAM), a synchronous dynamic RAM (SDRAM), a PRAM, a RRAM, a FeRAM, etc., and may be implemented in the form of a hard disk drive (HDD), a solid-state drive (SSD), a secure digital (SD) card, a micro-SD card, etc., or a combination thereof. The processor P may be implemented as an array of logic gates, a microprocessor, a central processing unit (CPU), a graphics processing unit (GPU), an application processor (AP), or a combination thereof.

The user server 200 may identify the second mark M2 which is a visible mark and provided on the product O. The user server 200 may be used by a user. In this case, the user server 200 may be operated in a web server manner without installing a separate dedicated application. As an example, the second mark M2 is a generally identifiable visual mark and may include a quick-response (QR) code, a barcode, etc. Further, the user server 200 may be a server device or a computer device.

In this case, the processor P may determine the distribution possibility of a counterfeit by identifying an abnormal price of the product O and tracing a distribution channel of the product O and may scan and match the first mark M1 and the second mark M2 in the product O that is highly likely to be counterfeit to determine whether the product O is counterfeit.

That is, the processor P may first determine the distribution possibility of the counterfeit by identifying the abnormal price of the product O and tracing the distribution channel of the product O, determine whether the product O is a product that is highly likely to be counterfeit, and then scan and match the first mark M1 and the second mark M2 to actually determine whether the product O is counterfeit.

In particular, the processor P may identify the abnormal price of the product O sold at an abnormal price compared to a normal price of the product O and notify a manufacturer of the product O of the abnormal price of the product O sold at the abnormal price.

Further, the processor P may identify the abnormal price of the product O sold at the abnormal price compared to the normal price of the product O and trace a distribution channel of the product O sold at the abnormal price.

Here, when the price of the product O is abnormally low or high, there may be a problem in the distribution channel of the product or it is highly likely that counterfeit products are distributed. Specifically, when the price of the product O is too low, it is highly likely that the product O is counterfeit, and when the price is abnormally high, it may be an illegal sale. Further, the distribution channel of the product O may be an important factor in determining whether the product O is genuine or counterfeit. In particular, an unusual distribution channel increases the distribution possibility of counterfeit products, and for example, when a product O is being sold through a channel other than the manufacturer's officially authorized distribution network, it is highly likely that that product O is counterfeit.

According to this implementation configuration, unlike conventional technologies, it is possible to determine whether the product O is counterfeit using both a visible mark and an invisible mark that is difficult to counterfeit, and thus there is an advantage in that it is possible to more accurately determine whether the product O is counterfeit.

Further, according to the product distribution management device 10 of the present invention, there is an advantage in that it is possible to identify prices of various products O and trace distribution channels of the products O to rapidly take an appropriate measure against abnormal prices and anomalous sales channels.

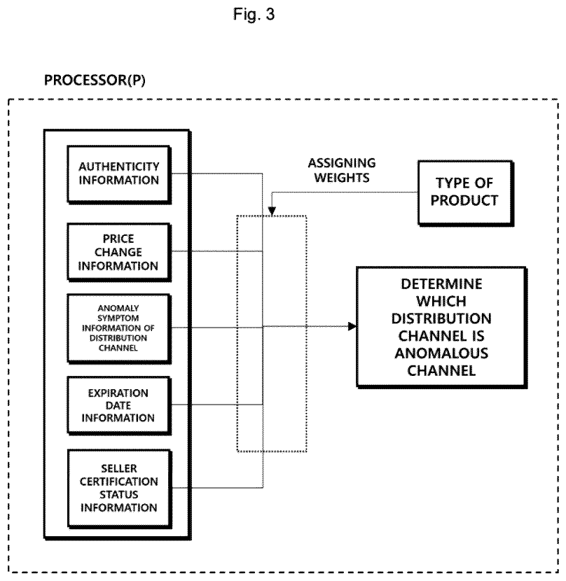

FIGS. 3 to 5 are diagrams illustrating other examples of the product distribution management method performed by the product distribution management device 10 of FIG. 1.

Referring to FIG. 3, when tracing a distribution channel of a product O sold at an abnormal price, the processor P may determine which distribution channel is an anomalous channel.

In particular, when determining which distribution channel is an anomalous channel, the processor P may consider at least one of authenticity information of the product O, price change information of the product O, anomaly symptom information of the distribution channel, expiration date information, and seller certification status information.

Further, the processor P may determine weights assigned to each of the authenticity information of the product O, the price change information of the product O, the anomaly symptom information of the distribution channel, the expiration date information, and the seller certification status information, according to the type of product O.

In an embodiment, when the product O is for domestic sale, greater weights may be set to the authenticity information of the product O and the anomaly symptom information of the distribution channel of the product O than to the expiration date information of the product O, the seller certification status information of the product O, and the price change information of the product O. This is because, when the product O is for domestic sale, the possibility of counterfeit products being produced due to anomalies in the distribution channel of the product O is greater than when the product O is for export overseas, and thus the authenticity information of the product O and the anomaly symptom information of the distribution channel of the product O are considered to be more important factors than the expiration date information of the product O, the seller certification status information of the product O, and the price change information of the product O.

Further, when the product O is for export overseas, greater weights may be set to the expiration date information of the product O, the seller certification status information of the product O, and the price change information of the product O than to the authenticity information of the product O and the anomaly symptom information of the distribution channel of the product O. This is because, when the product O is for export overseas, the possibility of counterfeit products being produced due to price differences in the product O is greater than when the product O is for domestic sale, and thus the expiration date information of the product O, the seller certification status information of the product O, and the price change information of the product O are considered to be more important factors than the authenticity information of the product O and the anomaly symptom information of the distribution channel of the product O.

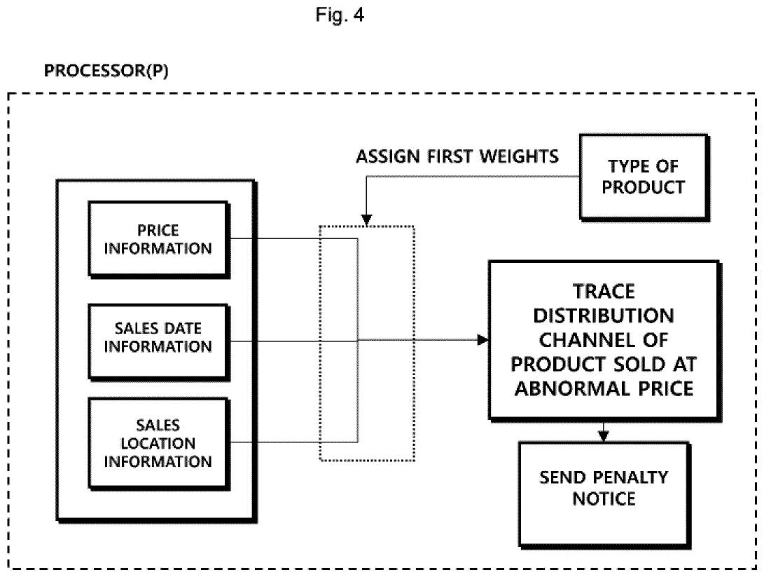

Referring to FIG. 4, when tracing the distribution channel of the product O sold at the abnormal price, the processor P may consider price information, sales date information, and sales location information (e.g., online/offline channel) on the product O that are sold by each distributor distributing the product O.

In particular, when tracing the distribution channel of the product O sold at the abnormal price, the processor P may determine first weights assigned to each of the price information, sales date information, and sales location information of the product O that are sold by each distributor.

In an embodiment, in the case in which the product O is a cosmetic or a pharmaceutical, when tracing the distribution channel of the product O sold at the abnormal price, the processor P may set a greater first weight to the price information of the product O than to the sales date information of the product O and the sales location information of the product O. This is because, when the product O is a cosmetic or a pharmaceutical, it is highly likely that counterfeit products are produced due to the price differences in product O, and thus the price information of the product O is considered to be a more important factor than the sales date information of the product O and the sales location information of the product O.

Further, in the case in which the product O is a food, when tracing the distribution channel of the product O sold at the abnormal price, the processor P may set greater first weights to the sales date information of the product O and the sales location information of the product O than to the price information of the product O. This is because, when the product O is a food, it is highly likely that counterfeit products are produced due to the distribution channel of the product O, and thus the sales date information of the product O and the sales location information of the product O are considered to be more important factors than the price information of the product O.

Further, when it is determined that the product O sold by the distributor is counterfeit, the processor P may send a penalty notice to a distributor who sold the counterfeit in consideration of the determined first weights. In an embodiment, the penalty notice may include measures such as sending a warning message to the distributor who sold the counterfeit, terminating the contract, imposing a fine, or the like.

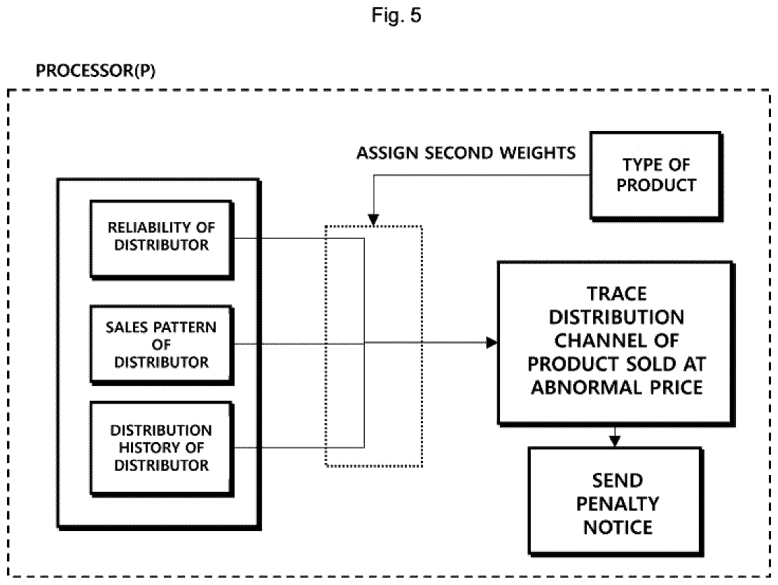

Referring to FIG. 5, when sending the penalty notice to the distributor who sold the counterfeit, the processor P may determine second weights assigned to each of reliability of the distributor, a sales pattern of the distributor, and distribution history of the distributor.

In an embodiment, in the case in which the product O is a cosmetic or a pharmaceutical, when sending the penalty notice to the distributor who sold the counterfeit, greater second weights may be set to the reliability of the distributor and the distribution history of the distributor than to the sales pattern of the distributor. This is because, when the product O is a cosmetic or a pharmaceutical, it is highly likely that counterfeit products are produced due to the reliability of the distributor and the distribution history of the distributor, and thus the reliability of the distributor and the distribution history of the distributor are considered to be more important factors than the sales pattern of the distributor.

In an embodiment, in the case in which the product O is a food, when sending the penalty notice to the distributor who sold the counterfeit, a greater second weight may be set to the sales pattern of the distributor than to the reliability of the distributor and the distribution history of the distributor. This is because, when the product O is a food, it is highly likely that counterfeit products are produced due to the anomalous sales pattern of the distributor, and thus the sales pattern of the distributor is considered to be a more important factor than the reliability of the distributor and the distribution history of the distributor.

Further, the processor P may adjust the degree of the penalty notice intended to be sent to the distributor who sold the counterfeit, in consideration of the first weights and the second weights.

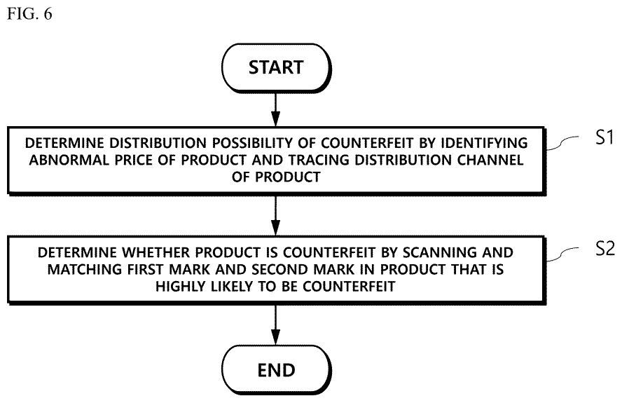

FIG. 6 is a flowchart illustrating a product distribution management method according to an embodiment of the present invention.

Referring to FIG. 6, the product distribution management method according to the embodiment of the present invention may include operations S1 and S2.

In operation S1, an abnormal price of a product O may be identified and a distribution channel of the product O may be traced to determine the distribution possibility of the counterfeit. In this case, operation S1 may be performed by the processor P described above.

In operation S2, a first mark, which is an invisible mark, and a second mark, which is a visible mark, in the product that is highly likely to be counterfeit may be scanned and matched to determine whether the product O is counterfeit. In this case, operation S2 may be performed by the processor P described above.

According to an aspect of the present invention, unlike conventional technologies, it is possible to determine whether a product is counterfeit using both a visible mark and an invisible mark that is difficult to counterfeit, and thus there is an advantage in that it is possible to more accurately determine whether the product is counterfeit.

Further, according to the product distribution management device of the present invention, there is an advantage in that it is possible to identify prices of various products and trace distribution channels of the products to rapidly take an appropriate measure against abnormal prices and anomalous sales channels.

In addition, according to various embodiments of the present invention, various additional effects can be achieved. These various effects of the present invention are described in detail in each embodiment, and descriptions of effects easily understood by those skilled in the art are omitted.

As described above, while the present invention has been described with reference to specific embodiments and drawings, the present invention is not limited thereto. It is clear by those skilled in the art that various modifications and alterations may be made without departing from the spirit and scope of the present invention and equivalents of the appended claims.

Meanwhile, although terms indicating directions such as up, down, left, right, front, and back are used in the present invention, it is obvious to those skilled in the art that these terms are only for the convenience of description and may vary depending on a location of a target object or a location of an observer.

What is claimed is:

1. A product distribution management device for tracing an anomalous sales act of a product by recognizing a counterfeit prevention means provided on the product, the product distribution management device comprising:
an administrator terminal including a processor configured to identify a first mark which is an invisible mark and provided on the product; and
a user server used by a user and configured to identify a second mark which is a visible mark and provided on the product, wherein the processor determines distribution possibility of a counterfeit by identifying an abnormal price of the product and tracing a distribution channel of the product, and scans and matches a first mark and a second mark in the product that is highly likely to be counterfeit to determine whether the product is counterfeit.

2. The product distribution management device of claim 1, wherein the processor is configured to identify the abnormal price of the product sold at an abnormal price compared to a normal price of the product and notify a manufacturer of the product of the abnormal price of the product sold at the abnormal price, and identify the abnormal price of the product sold at the abnormal price compared to the normal price of the product and trace the distribution channel of the product sold at the abnormal price.

3. The product distribution management device of claim 2, wherein, when tracing the distribution channel of the product sold at the abnormal price, the processor determines which distribution channel is an anomalous channel.

4. The product distribution management device of claim 3, wherein, when determining which distribution channel is an anomalous channel, the process is configured to consider at least one of authenticity information of the product, price change information of the product, anomaly symptom information of the distribution channel, expiration date information, and seller certification status information, and determine weights assigned to each of the authenticity information of the product, the price change information of the product, the anomaly symptom information of the distribution channel, the expiration date information, and the seller certification status information, according to a type of the product.

5. The product distribution management device of claim 2, wherein, when tracing the distribution channel of the product sold at the abnormal price, the processor is configured to consider price information, sales date information, and sales location information of the product that is sold by each distributor distributing the product.

6. The product distribution management device of claim 5, wherein, when tracing the distribution channel of the product sold at the abnormal price, the processor is configured to determine first weights assigned to each of the price information, the sales date information, and the sales location information of the product that is sold by each distributor, and
when it is determined that the product sold by the distributor is a counterfeit, send a penalty notice to a distributor who sold the counterfeit in consideration of the determined first weight.

7. The product distribution management device of claim 6, wherein, when sending the penalty notice to the distributor who sold the counterfeit, the processor is configured to determine second weights assigned to each of reliability of the distributor, a sales pattern of the distributor, and distribution history of the distributor, and
adjust a degree of the penalty notice intended to be sent to the distributor who sold the counterfeit, in consideration of the first weights and the second weights.

8. A product distribution management method using a product distribution management device for tracing an anomalous sales act of a product by recognizing a counterfeit prevention means provided on the product, the product distribution management method comprising:
determining distribution possibility of a counterfeit by identifying an abnormal price of the product and tracing a distribution channel of the product; and
scanning and matching a first mark, which is an invisible mark, and a second mark, which is a visible mark, in the product that is highly likely to be counterfeit to determine whether the product is counterfeit.
